(19) United States
(12) Patent Application Publication
(10) Pub. No.: US 2014/0114684 A1
(43) Pub. Date: Apr. 24, 2014

(54) HEALTHCARE ENTERPRISE COMMUNICATIONS MANAGEMENT

(71) Applicant: Douglas D. Semian, Atlanta, GA (US)

(72) Inventor: Douglas D. Semian, Atlanta, GA (US)

(21) Appl. No.: 14/142,070

(22) Filed: Dec. 27, 2013

Related U.S. Application Data
(63) Continuation-in-part of application No. 12/976,673, filed on Dec. 22, 2010, now abandoned.
(60) Provisional application No. 61/288,943, filed on Dec. 22, 2009.

(51) Int. Cl. G06F 19/00

(52) U.S. Cl. CPC G06F 19/327
USPC 705/2

(57) ABSTRACT

Technologies are described herein for coordinating scheduling and communications. Through an implementation of the concepts and technologies presented herein, functionality can be provided for aggregating scheduling and communication information indicating one or more contact modalities, schedules, and responsibilities. The scheduling information can be edited to establish and adjust shifts and duties. The aggregated information can be communicated among various users. Communicating the aggregated information can support the use of various communication modalities to significantly improve accuracy, timeliness, and appropriateness of coordination and communication amongst the users.

### CROSS-REFERENCE TO RELATED APPLICATION

This application is a continuation-in-part of U.S. non-provisional patent application Ser. No. 12/976,673, filed on Dec. 22, 2010, entitled “Scheduling and Communications System and Method,” and claiming the benefit of U.S. provisional patent application No. 61/288,943, filed on Dec. 22, 2009, entitled “Scheduling and Communications System and Method,” both of which are expressly incorporated herein by reference in their entirety.

### BACKGROUND

Individuals or groups associated with various enterprise operations, such as hospitals and other healthcare organizations and entities, need to communicate with one another in an accurate, timely, and appropriate manner in order to render decisions and execute tasks despite their geographic and temporal displacements throughout the enterprise.

It is with respect to these and other considerations that the disclosure made herein is presented.

### SUMMARY

Concepts and technologies are described herein for coordinating scheduling and communications. Through an implementation of the concepts and technologies presented herein, functionality can be provided for aggregating scheduling and communication information indicating one or more contact modalities, schedules, and responsibilities. The scheduling information can be edited to establish and adjust shifts and duties. The aggregated information can be communicated among various users. Communicating the aggregated information, according to specified policies, can support the use of various communication modalities to significantly improve accuracy, timeliness, and appropriateness of coordination and communication amongst the users.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system block diagram illustrating aspects of a scheduling and communication system according to various embodiments presented herein;

FIG. 2 is a data structure diagram illustrating aspects of team assignments according to various embodiments presented herein;

FIG. 3 is a data structure diagram illustrating aspects of aggregation and linking within an example hospital enterprise according to various embodiments presented herein;

FIG. 4 is a data structure diagram illustrating aspects of duty mapping of clinical providers to emergency department on-call duty periods within a hospital enterprise according to various embodiments presented herein;

FIG. 5 is a data structure diagram illustrating aspects of a shift group with a duty period according to various embodiments presented herein;

FIG. 6 is a data structure diagram illustrating aspects of direct communication management according to various embodiments presented herein;

FIG. 7 is flow diagram showing aspects of one process presented herein for coupling schedule and communication information according to one or more embodiments presented herein;

FIG. 8 is a flow diagram showing aspects of one process presented herein for scheduling end user shifts according to one or more embodiments presented herein;

FIG. 9 is a system block diagram illustrating aspects of a system infrastructure according to various embodiments presented herein; and

FIG. 10 is a computer architecture diagram showing an illustrative computer hardware and software architecture for a computing system capable of implementing aspects of the various embodiments presented herein.

### DETAILED DESCRIPTION

The following detailed description is directed to technologies for coordinating scheduling and communications. The technology presented herein can support aggregating scheduling and communication information indicating one or more contact modalities, schedules, and responsibilities.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system, computer-readable storage medium, and computer-implemented methodology for coordinating scheduling and communications will be presented.

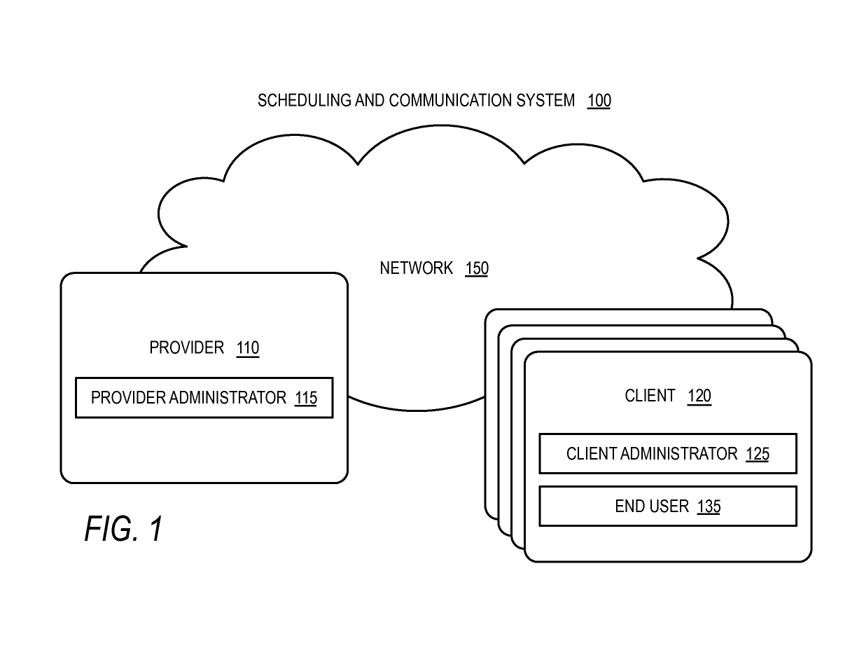

Referring now to FIG. 1, a system block diagram illustrating aspects of a scheduling and communication system 100 according to various embodiments presented herein will be described. The scheduling and communication system 100 may comprise a provider 110 and one or more clients 120 connected within a network 150. Provider administrators 115 may be associated with the provider 110. Client administrators 125 and end users 135 may be associated with each of the clients 120.

End users 135 may be considered stakeholders of operations and services associated with the respective clients 120. For example, the end users 135 may include clinical healthcare providers practicing in association with one or more clients 120 where the clients 120 are each one or more hospitals, physician practices, or other healthcare organizations or entities. Thus, the clinical healthcare providers may be considered stakeholders of operations and services provided within the hospitals.

The scheduling and communication system 100 can support associating an end user 135 with one or more work responsibilities. An end user 135 may also be associated with one or more duty periods. An end user 135 may also be associated with one or more communication modalities. For example, one end user 135 may be associated with a mobile device, a wireless internet protocol (IP) telephone, a voice over IP (VoIP) telephone, a telephone number for text messages, an email address, an identifier for instant messaging, and various other communication modalities as discussed in further detail below. The scheduling and communication system 100 can support aggregating information for an end user 135 indicating one or more of their contact modalities, schedules, and responsibilities. Furthermore, the scheduling and communication system 100 can support communicating this aggregated information to other end users 135, client administrators 125, or both according to specified policies. Communicating the aggregated information, according to specified policies, can support use of the various communication modalities to significantly improve accuracy, timeliness, and appropriateness of coordination and communication amongst the end users 135 and other stakeholders

According to the hospital example, an end user 135 clinical provider may be able to more effectively contact another end user 135 clinical provider according to the appropriate shift schedule and responsibility assignment using the most appropriate communication modality. As such, an end user 135 in an emergency department can determine from schedule and responsibility information which clinical subspecialist end user 135 is currently on-call to the emergency department. The end user 135 in the emergency department may also ascertain which communication modality the clinical subspecialist end user 135 should be contacted though. For example, a mobile phone call or text message may be issued directly between these two end users 135 from information aggregated and communicated by the scheduling and communication system 100.

Extending the example embodiment there the clients 120 are hospitals or networks of hospitals, the end users 135 may be considered intra-hospital entities or extra-hospital entities. Some examples of intra-hospital end users 135 may include physicians, clinical subspecialists, nurses, respiratory therapists, occupational and physical therapists, pharmacists, discharge planners, emergency room secretaries, nursing units, operating rooms, patient customer services, and various other actors within the hospital enterprise. Some examples of extra-hospital end users 135 may include nursing homes, specialists, pharmacies, physician offices, outpatient diagnostics, laboratory centers, and various other individuals or organizations outside the hospital enterprise. Thus, the scheduling and communication system 100 can support improved communication among end users 135 other than those functioning within hospitals and their associated health networks.

Within the hospital example, the scheduling and communication system 100 can support mitigating a major common bottleneck in the delivery of high-quality healthcare. That bottleneck is the requirement for direct communication between two or more end users 135. Within a hospital, such direct communication requirements may exist to ensure the exchange of clinically-relevant information, medical decision-making, and order execution in a prompt and reliable manner. The scheduling and communication system 100 can inform one end user 135 specifically which other end user 135 needs to be contacted, when to contact them, and how to contact them. Expediting these direct communication events can positively impact established operational metrics by which hospitals and health networks are generally evaluated. The metrics include, but are not limited to, lengths of patient stay, care delivery costs, customer satisfaction, and clinical outcomes.

Hospitalist services are integral to efficient hospital operations. A hospitalist may be a physician, or a nurse practitioner or physician assistant being supervised by a physician, functioning within a hospital as the primary clinical professional and, hence, final arbiter of all healthcare decisions and care coordination associated with one or more admitted patients. One or more hospitalist clinical providers may be end users 135 of the scheduling and communication system 100 associated with a hospital. The scheduling and communication system 100 can improve communication between two or more hospitalist end users 135. The scheduling and communication system 100 can also improve communication between a hospitalist end user 135 and other end users 135 that need to interface with the hospitalist end user 135.

In addition to these example embodiments involving hospital and healthcare enterprises, it should be appreciated that the scheduling and communication system 100 may be adapted to other enterprises environments according to various other example embodiments. Such other enterprise environments may include any enterprise, or combinations or enterprises, where scheduling of resources, individuals, or groups of individuals may be coupled with supporting communication between those resources, individuals, or groups of individuals according to specified policies. Various examples of such enterprises may include industrial, logistic, military, supply chain, shipping, education, financial, management, law enforcement, correctional facilities, transportation, manufacturing, and many others.

A provider administrator 115 may be employees or agents associated with the provider 110 of the scheduling and communication system 100. The provider administrators 115 may have access to administrative functions of the scheduling and communication system 100 on the side of the provider 110. These administrative functions may include the ability to create, delete, and modify information associated with organizations, clients 120, schedules, shifts, shift requests, report generation, client administrators 125, company codes, services, qualifications, employees, end users 135, and various other data and functions supported by the provider 110. The shift data may include aggregation links, shift titles, shift labels, duties periods, duty period labels, and other shift and schedule parameters as discussed in further detail below.

One or more provider administrators 115 may be associated with a specified client 120. Such an association may support authority of administrative control for the specified client 120 by the specified provider administrators 115. Thus, approved provider administrators 115 may support clients 120, client administrators 125, and end users 135 of the scheduling and communication system 100.

Provider administrators 115 may access report generation functionality associated with the scheduling and communication system 100. Such functionality may include client billing, application usage monitoring, and custom reporting. Client billing reports may support provider administrators 115 to determine usage metrics of the scheduling and communication system 100 by clients 120 over a period of time. (E.g. over one calendar month.) A provider administrator 115 may periodically generate a report on client-specific shift, schedule, and user account information. From such a report, the respective client 120 may be billed for its usage of the scheduling and communication system 100.

Application usage monitoring reports can be generated by provider administrators 115 to periodically monitor usage trends of the scheduling and communication system 100 by clients 120. Such reports can identify peaks and troughs of client usage to better enable the provider 110 to prepare for and allocate the appropriate level of service resources as usage varies over time.

Custom reporting can be used by provider administrators 115 to create custom reports for such administrative functionality as database administration, software development, software debugging, data analysis, internal business analysis, consultative analysis to clients 120, other data mining, analysis, or any other administrative reporting function.

The scheduling and communication system 100 may include two types of users on the side of the client 120. These may include client administrators 125, and end users 135. Client administrators 125 can administrate and maintain the scheduling and communication system 100 the respective client 120. The functions available to the client administrators 125 may include shift request administration, report generation, monitoring of end users 135, and management of company code, associated organization, associated services, qualifications, and employees. Various other functions may be supported for use by the client administrators 125 according to the application specific details of the respective client 120.

End users 135 associated with a particular client 120 may use the company code associated with that client 120 along with a user name and password to access services within the scheduling and communication system 100. End users 135 may also store, maintain, and prioritize a set of contact information and contact modalities within an account associated with the end user 135. End users 135 may be assigned responsibilities such as specific qualifications within particular services to clearly define their role and function within the enterprise of the client 120. The Qualifications for an end user 135 may be determined and assigned by a provider administrator 115 and/or a client administrator 125. These qualifications associated with an end user 135 may determine what scheduling and contact information the end user 135 may access and in which specific shifts in specific schedules an end user 135 may participate.

An end user 135 can access functions within the scheduling and communication system 100 such as end user shift assignments, group shift assignments, group contact information, shift request, and various others. An end user 135 may be both and end user and a client administrator 125. Client administrators 125 may generate various reports such as compensation determination and census monitoring.

Each client 120 within the scheduling and communication system 100 may be assigned a unique company code. The company code may be used for client-side user identification, intra-client organization administration, intra-client and inter-client information exchange and administration, provider-side administration. Provider-side administration may include client and usage reporting associated with the scheduling and communication system 100.

A client 120 may be considered, or represented as, an administrative hierarchy. For example, the client 120 may comprise one or more organizations having a hierarchy of services grouped within each organization. A service may describe a subdivision that is part of the organization. According to some examples, a subdivision may be a geographic location. In the hospital example, an organization may be a network of multiple hospitals with each hospital being a service. A client 120 may also be organized by qualifications such as the functions or titles of end users 135. The qualification may then be subdivided into groups of services. Various other administrative hierarchical structures of end users 135 associated with a particular client 120 may be established according to the operations and needs of the client 120.

A client 120 may be also be considered, or represented as, a schedule organization. The functionality of the administrative hierarchy may be shared with the schedule organization mechanism within the scheduling and communication system 100. One or more schedule groups may be associated with each service. The schedule groups may be groups of schedules for end users 135. Schedule groups may add a layer of flexibility and customization according to the scheduling needs of each client 120. These may be configured to mirror the structure of the client's enterprise.

Schedule codes may be associated with the schedule groups. A schedule code may be a multiple character designation assigned to a specific schedule or series of schedules so that schedules of end users 135 may be logically linked and associated. By linking schedules together in a highly flexible and sophisticated manner, schedule codes may be used to create powerful and robust reports from the linked schedule data. Further, end users 135 may organize their schedules in a logical manner to mirror the structure of the enterprise of the client 120.

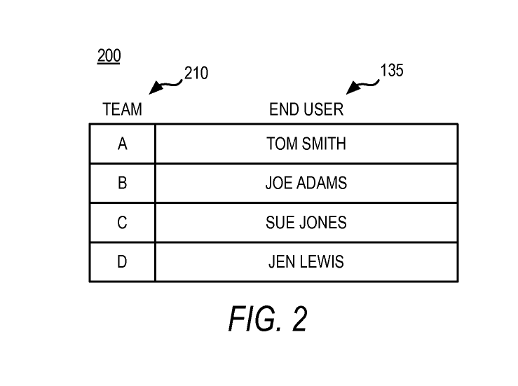

Referring now to FIG. 2, a data structure diagram illustrating aspects of team assignments 200 according to various embodiments presented herein will be described. Each client 120 may define teams 210 of end users 135 as working at the same span of time within the same service. These teams 210 may be thought of as sets, groups, bands, platoons, squads, divisions, associations, gangs, or any other collections of end users 135. At any given time, a particular end user 135 may be assigned to a specific team 210.

In the illustrated example definition of teams 210, Tom Smith is associated with team A, Joe Adams is associated with team B, Sue Jones is associated with team C, and Jen Lewis is associated with team D. While letters are used to label the teams in this example, it should be appreciated that numbers, colors, symbols, strings, names, any other identifiers, or combinations thereof may be use to indicate teams 210.

Considering an example embodiment where the client 120 is a hospital enterprise, each team 210 may be associated with a particular clinical provider end user 135. That clinical provider end user 135 may be a clinical provider of hospital medicine services who is associated with a specific group of patients for a specific span of time associated with the team assignment 200.

The scheduling and communication system 100 may be used to determine which clinical provider end user 135 is associated with a given team 210 and thus a specific group of patients for a particular shift within a schedule. The scheduling and communication system 100 may also provide the communication modalities associated to that particular end user 135 thus facilitating timely communication with the correct end user 135 associated, at a given time, with a particular patient. The end users 135 may also use the scheduling and communication system 100 to identify other end users 135. These other end users 135 may be other hospitalist service clinical providers, subspecialty clinical providers, other intrahospital clinical stakeholders such as nurses, and pharmacists, and extra-hospital end users including laboratory and radiology departments and various other entities throughout the healthcare enterprise. It should be appreciated that specific teams may also be created and assigned to clinical providers of the hospitalist service for night shifts, swing shifts, and so forth.

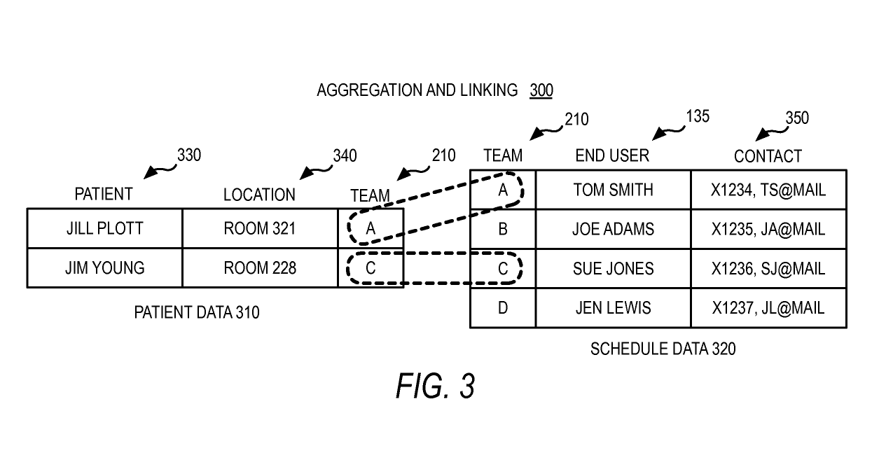

Referring now to FIG. 3, a data structure diagram illustrating aspects of aggregation and linking 300 within an example hospital enterprise according to various embodiments presented herein will be described. Patient data 310 and schedule data 320 for end users 135 may be linked together within an example hospital embodiment of the scheduling and communication system 100. Team indicators 210 may be associated with a particular responsibility or service. In the hospital example, the responsibility or service may be a patient 330. Aggregation and linking functionality within the scheduling and communication system 100 can associate end users 135 through their team 210 indicators to corresponding responsibilities or patients 330. The scheduling and communication system 100 can also generate an aggregated schedule and contact book from identification information, contact information, and scheduling information associated with an end user 135 along with indication of their team identifier.

Teams 210 may be used to group responsibilities or services together for assignment to an end user 135. As discussed, in the hospital example embodiment, the teams 210 may be collections of patients assigned to a particular physician end user 135. Patient data 310 may be stored in a clinical information system (CIS) or a hospital information system (HIS) to associate locations 340 with a patient 330. An additional entry for the team 210 associated with the patient 330 can support establishing linking between the patient data 310 and the schedule data 320. Since the schedule data 320 can associate end users 135 with teams 210 and contact modalities 350, the link supports a connection between a patient 330 and the appropriate end user 135 physician as well as the contact 350 information associated with that end user 135.

The time an end user 135 clinical provider can care for patients is a very valuable resource that is in extremely limited supply. Anything that detracts from this time interrupts the end user 135 clinical provider's workflow and is potentially detrimental to the care of their patients. A common cause of workflow disruption is clinical providers being paged and contacted regarding patients that are assigned to another clinical provider or when that particular provider is no longer responsible for the care of a particular patient. Thus, the hospital environment is a particularly apt example of a domain that may benefit from the real-time coordination of schedule information, responsibilities information, and contact information. The scheduling and communication system 100 can support the real-time coordination, linking, and aggregation of such information.

The linking of patient data 310 and the schedule data 320 may be supported in a fashion that is agnostic to the particular CIS/HIS system used to manage the patient data 310. Adding an identifier for a specific team 210 to each patient within the CIS/HIS can support linking of the patient data 310 and the schedule data 320 by the scheduling and communication system 100 according to technology disclosed herein.

There are essential pieces of information that can be collected to support an end user 135 clinical provider in caring for a patient. These can include who the patient is, where the patient is located, and which clinical provider is responsible for the care of the patient. While CIS/HIS solutions may traditionally manage patient identification and location information, the scheduling and communication system 100 discussed herein can link this patient data 310 to schedule data 320 for the end users 135 and thus establish a link between the patient's identification and location, and assignment of which clinical provider is responsible for care the patient based on end user 135 schedules. Furthermore, various contact modalities for the end user 135 may also be provided once the end user 135 is identified. It should be appreciated that no protected health information (PHI) needs to be stored with the schedule data 320. Thus, the provider 110 may be kept separated from any sensitive patient data 310. This can support reducing the risk or liability of compromising sensitive information.

It should be appreciated that while this technology is illustrated using an example embodiment of patients and clinical healthcare providers, the technology may be applied to a variety of embodiments and applications as discussed herein. For example, the end users 135 may instead be delivery drivers and the responsibilities/services may be delivery routes or delivery vehicles instead of patients or team assignments.

An aggregated schedule and contact book may be established by the scheduling and communication system 100. This may include a comprehensive data repository of scheduling and contact information for a specific client 120. A daily scheduling and contact book may be established as the subset of the comprehensive data repository that is relevant to the scheduling and contact information for the current calendar day. This data repository is created, stored, and managed by the Schedule Blue service. Data may include each end user 135 scheduled for that day, each end user's team 210 assignment for that day, and various categories of contact modalities and clinical responsibilities as discussed below. For example, the contact modalities may include a pager number, an email address, and an IP telephone number. The various users of the scheduling and communication system 100, such as the end users 135 or client administrators may access subset contact books or daily books to obtain information to communicate and coordinate with other end users 135 and stakeholders within the enterprise.

In one hospital environment example, a daily schedule and contact book may be accessed by each of the clinical provider end users 135 active for a given day. This daily schedule and contact book may provide information such as a list of the active clinical providers for the day, what team each clinical provider is associated with, and the contact information for each of the clinical providers. Also, a charge nurse (a supervisory nurse on a nursing unit) may access the daily schedule and contact book to identify and contact the specific clinical provider associated to a particular patient via the patient's team assignment. As such, the scheduling and communication system 100 can support the nurse's ability to contact the physician accurately, quickly, and appropriately so that clinical information can be reported, clinical questions answered, and clinical orders executed.

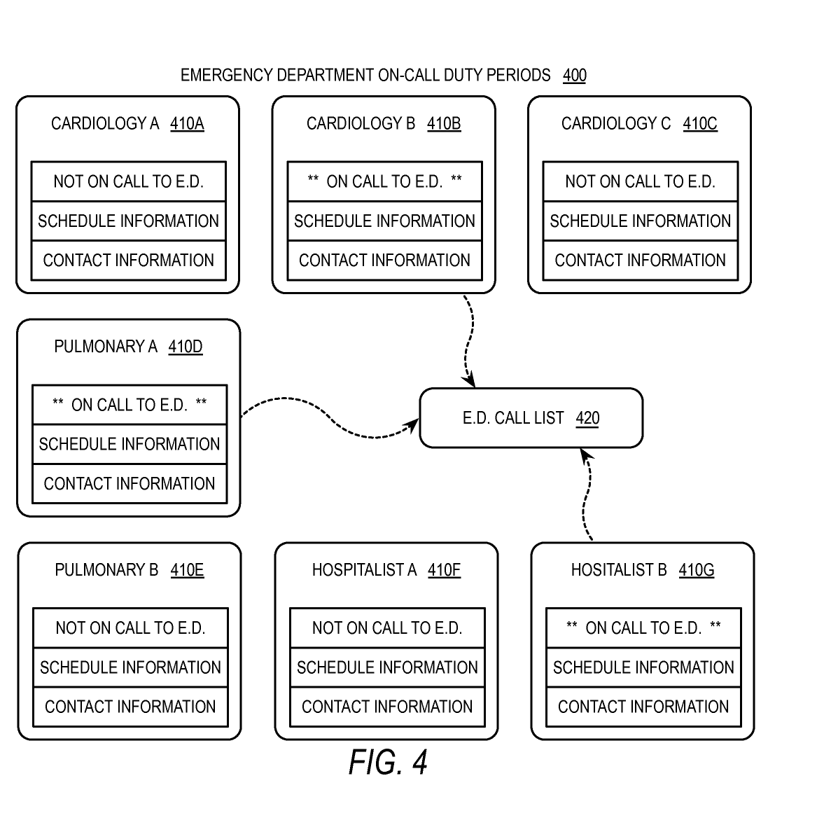

Referring now to FIG. 4, a data structure diagram illustrating aspects of duty mapping of clinical providers to emergency department on-call duty periods 400 within a hospital enterprise according to various embodiments presented herein will be described. Seven services 410A-410G can operate within a hospital enterprise. One group of clinicians within a specific subspecialty (cardiology, pulmonary, hospitalist, etc.) may be assigned duty as “on call to the emergency department” for the given duty period. Generally one of a multiplicity of groups within a particular subspecialty will be designated as on-call to the emergency department. For example, one cardiology group, one pulmonary group, one hospitalist service, and so forth. In the illustrated example these services are cardiology B 410B, pulmonary A 410D, and hospitalist B 410G.

Each on-call group or service 410 for a given subspecialty may be compiled into an emergency department call list 420. The emergency department call list 420 may be applicable for a 24 hour period or some other specified duration of time. The emergency department call list 420 can provide the specific end users 135 within each on-call group 410B, 410D, 410G that should be contacted by the emergency department for clinical consultative and admitting services during the particular duty period assignment. The end user's 135 contact information may also be provided. The scheduling and communication system 100 can generate and communicate the emergency department call list 420 to end users 135 based on scheduling and contact information to support the efficient coordination of end users 135 responsible for duty with the emergency department. According to other example embodiments, the emergency department call list 420 may be generalized to an aggregated common duty list.

It should be appreciated that, in addition to supporting various modalities of communication for contact information, the scheduling and communication system 100 can support different scopes of contact information. One example of a scope of communication information may be user-specific contact information such as an email address or pager number that would always be assigned to a specific end user 135. Another example of a scope of communication information may be service-specific contact information such as a pager number that is associated with Team A even as different end users 135 are associated with Team A. Yet another example of a scope of communication information may be shift-specific contact information such as an IP telephone number that is associated with the night shift doctor even as different end users 135 fill the roll of the night shift doctor. The communications information within the scheduling and communication system 100 may also support various other scopes of contact information according to various embodiments.

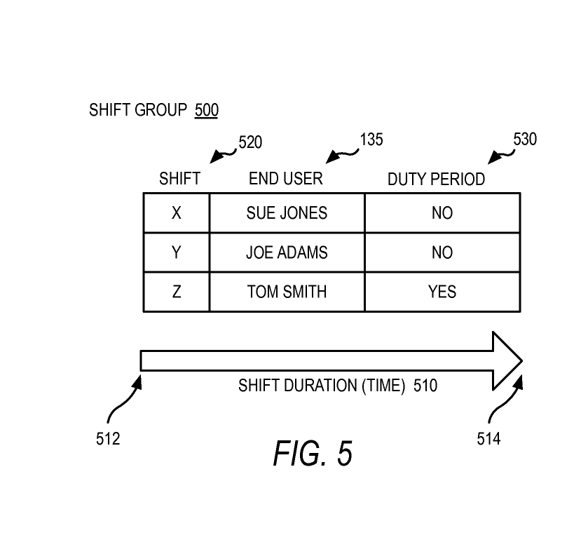

Referring now to FIG. 5, a data structure diagram illustrating aspects of a shift group 500 with a duty period 530 according to various embodiments presented herein will be described. The shift 520 may be a basic element of the scheduling mechanism within the scheduling and communication system 100. The shift 520 may be a period in time when an end user 135 is expected to be accessible to the client 120 in the context of employment or other responsibility. For example, the end user 135 may be called upon to render clinical decisions or professional advice, execute orders, perform tasks, and so forth. In return, the client 120 generally compensates the end user 135 according to the terms of employment.

The shift 520 may have a shift duration 510 as a specified amount of time. The instant in time when the shift 520 begins may be referred to as the shift start time 512. The instant in time when the shift 520 ends may be referred to as the shift end time 514. According to some examples, a unit that may be used to describe a shift 520 is a day. For example an end user 135 may be working on Tuesday or on the second of March. Alternatively, the shifts 520 may be defined by other conventional units of time (e.g., blocks of hours, weeks, hours). It should be noted that the time unit of a day need not be a literal 24 hour day, but may instead refer to a fractional portion of a day, multiple fractions of days, or multiple days. For example, some shifts 520 may have a shift duration 510 of eight, ten, or twelve hours.

An end user 135 may have one or more responsibilities or duties during a shift 520. These responsibilities may be distinctly identified and separated from one another or, alternatively, combined in aggregate. The period of time during which each end user 135 is assigned to a distinct responsibility may be called a duty period 530. The assignment of duty periods 530 can change as time passes from shift start time 512 to shift end time 514. Thus, one end user 135 can be assigned multiple contiguous or overlapping duty periods 530 during a single shift 520. This may related to the end user 135 having multiple duties or responsibilities during the shift duration 510. The quantity, type, and definition of duty periods 530 may differ from industry to industry as well as from client 120 to client 120. Regardless, duty periods 530 can enable the detailed tracking and assignment and tracking of changing work responsibilities of end users 135 within an enterprise.

A group of end users 135 can work together during their shifts and share their workload collectively and collaboratively. Such a collective group of shifts may be referred to as a shift group 500. A shift group 500 may be considered a group of similar shifts 520 that may differ in terms of work responsibility assignments known as duty periods 530. The time element associated with a shift group may be a day with shift spans within the shift group being a fraction of that day, such as eight to twelve hours. It should be appreciated that any other duration for shift groups 500, shifts 520, or duty periods 530 may be used according to the needs of the client 120. Shifts 520 within a shift group 500 may all have the same shift start time 512 and shift end time 514, although in some applications the start and end times may vary according to the needs of the client 120.

The assignment of duty periods 530 to each individual shift 520 within the shift group 500 can support the delegation and equitable distribution of work responsibilities amongst the different end users 135. According to one or more hospital example embodiments, one or more end users 135 may be assigned to be on-call to the emergency department according to a duty period 530 specifying that responsibility. According to the illustrated example, end user 135 Tom Smith is associated with Shift Z and is assigned the illustrated duty period 530 which the end users 135 associated with Shift X and Shift Y are not assigned the duty period 530. In an example where the illustrated duty period 530 is associated with being on-call to the emergency department, the end user 135 Tom Smith will be available during the illustrated shift 520 to support the emergency department. However, the Shift X end user and the Shift Y end user are not assigned to be available to support the emergency department. Furthermore, the scheduling and communication system 100 can indicate to end users 135 within the emergency department that Tom Smith is on-call to them to provide clinical consultative and admitting services. Also, the scheduling and communication system 100 may provide the end users 135 within the emergency department with the various communication modalities for reaching the end user 135 Tom Smith. It should be appreciated that while the illustrated example shows only one duty period 530 as represented by one column, multiple duty periods 530, each with a different column, may exist and be assigned to different clinical providers within a shift group 500 as discussed above.

A Schedule may be an organized collection of consecutive, or sequential, shift groups 500. The time span for a schedule may be a calendar month, though in some applications the time span can be weeks, days, or any other time units. A schedule template may be constructed for a given service. The schedule template may be used for creating schedules for a given service. A schedule template may be used to provide a repository of data elements and structures used to create a series of similar, associated and consecutive schedules. These data elements and structures can include, but are not limited to schedule codes, start of week, shift sort order, on-schedule contact information, team names and assignments, participating types of qualifications, shift titles, shift classes, shift patterns, and any other structures used by a client 120 to form schedules. Initially, one or more schedule templates may be created per service and the schedule template can be modified as the needs and scope of the service change. A shift pattern may be a compilation of consecutive shift groups 500. A shift pattern may be created for a specific schedule template. A shift pattern may be used to create shifts 520 on a schedule that has been created from a schedule template. A new shift pattern may be created for a schedule template as the associated service expands and/or contracts.

The scheduling and communication system 100 can support a flexible and customizable mechanism for editing shifts 520 on schedules. The shift editing mechanism can display the shift 520 and schedule data elements in the desired manner. An example of the display options available may include choosing individual shift 520 and schedule data elements as well as the display options. The options may include the ability to alter the axes of the displayed schedule information to various views such as calendar view, day versus title, day versus class, day versus end users 135, or any other views useful to the client 120. Various modes for the Shift Editor can include, but are not limited to, previewing shifts, quick shift edit, add/delete shifts, individual shift edit, assign title/class, staff individual shifts, staff shifts based on title/class, add/remove qualification, import shift pattern from schedule template, handle end user requests, and so forth.

The scheduling and communication system 100 can support shift trading and exchange using end user requests. Rather than simply providing an information retrieval service for end user schedules, the request mechanism can support the ability for end users to trade and exchange shifts. This may be supported by the scheduling and communication system 100 rather than having to manually handle schedule changes outside the system. The shift request types that the scheduling and communication system 100 can process include, but are not limited to pickup open shifts, trade with open shifts, pickup advertised shifts, advertise shifts, remove advertisements, drop shifts, exchange shifts, and avoid shifts. It should be appreciated that exchange shifts request may involve a stepwise process by not just one, but two, end users 135 to initiate and complete.

A request period may be established as the span of time within which a request can be submitted by an end user 135. Establishing one or more request periods can support enabling the request mechanism, promoting shifts for pickup, establishing blackout periods for shift exchange, selectively targeting shifts to specific end users 135, improving work/life balance for end users 135, and other benefits of encouraging timely processing of shift requests.

A lead time for the request period may also be established to specify how long before the start of a shift that a request can be submitted. The lead time feature can support policies regarding that latest time that end users 135 can submit requests for a shift 520 within a request period. A sufficient window can be provided within which a client administrator 125 can approve or disapprove requests before shifts in question actually begin.

The scheduling and communication system 100 can be directed to handle an end user 135 shift request in an automated fashion. Alternatively, the shift request may be handled as to require administrative approval (RAA). This specification can support flexibility to automate or restrict how shift requests are handled. For an automated request, the request may not hold for additional input from a client administrator 125. However, the end user 135 submitting the request may still be filtered for possessing the proper qualifications. Also, the request may be verified to fall within the designated lead time of the request period. In the automated case, shift requests may be automatically settled on a first-come, first served basis. For a RAA shift request, this request can hold for additional administrative input by the client administrator 125 before the request may be granted or declined.

The shift request mechanism can support an equitable and transparent economy by which shifts can be exchanged. The exchanges may still be overseen by a client administrator 125. Automating shift adjustment directly by the end users 135 may be far more efficient than manual processing. Also, the client 120 need not go through a slow, manual offer and acceptance process via telephone or email to fill additional shifts when needed. This can represent a significant saving in time and cost. In the hospital example, such shift staffing can be particularly expensive when clients 120 resort to utilizing outsourced physician staffing services (i.e. locum tenens agencies) to fill their open and unfilled clinical provider work shifts. It is worthy to note, however, that a locum tenens agency may also benefit from being a client 120 of the scheduling and communication system 100 to manage the professionals they have available for shift staffing.

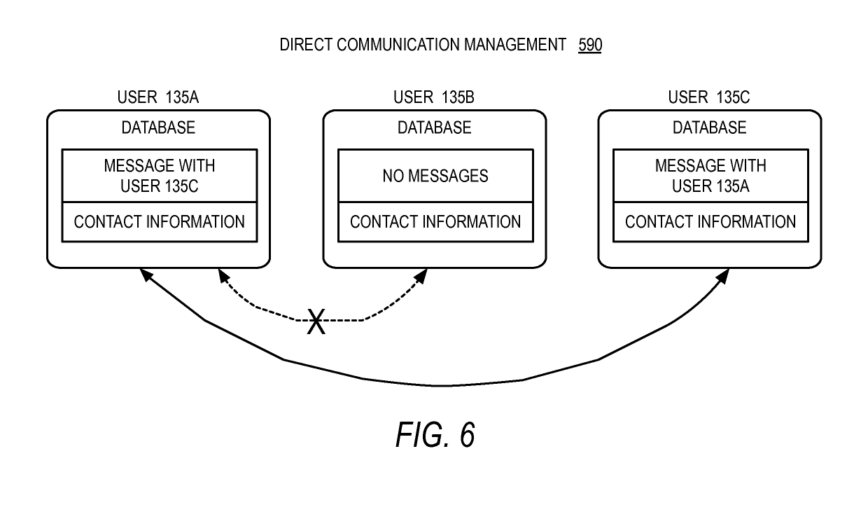

Referring now to FIG. 6, a data structure diagram illustrating aspects of direct communication management 590 according to various embodiments presented herein will be described. The direct communication management functionality 590 can support communication between two end users 135 that are the correct two clinical stakeholders to communicate on a given matter. By enabling a conversational role (involving messages such as those used in SMS or instant message conversations) to be transitioned from one end user 135 to another, the correct parties may efficiently communicate about a situation, and simultaneously those who are no longer or not yet required to be informed may remain free of interruption from notifications, alerts, and related distractions.

According to one three-party example, direct communication management functionality 590, end user 135A, end user 135B, and end user 135C are able to quickly communicate with the correct party while leaving irrelevant parties out of the communication. The illustrated example workflow may have initiated with end user 135A and end user 135B engaging in communication by passing messages according to the appropriate contact information for each user. According to the example end user 135B may determine that end user 135C is the appropriate party to take over communication with end user 135A on this matter and similarly, end user 135B may no longer be relevant to the conversation. At that time, end user 135B may initiate a transfer of the current conversation thread from himself or herself to end user 135C according to the contact information maintained within the system. End user 135A may then receive a notification that end user 135B is no longer in the conversation and that end user 135C is now the recipient of any related messages. End user 135A and end user 135C are now in a conversation with each other and end user 135B is no longer receiving the messages from the conversation. The messages may include text messages, SMS text messages, instant messages, electronic mail, voice communications, notifications, or any other electronic messages.

In an example application of direct communication management functionality 590 for a healthcare enterprise, the technology can seek to impact the rate-limiting step of direct communication between two key clinical stakeholders. A patient Case Manager may be in the role of end user 135A, and an Attending Provider (a designated clinician who issues orders impacting hospital reimbursement and timeliness of patient discharges) may be in the role of end user 135B. As end user 135B transitions their care of a patient to one or more healthcare vendors (those companies who receive patient referrals from hospitals and provide clinical services to patients in either a facility or outpatient setting), an individual associated with a vendor may be in the role of end user 135C. Communications from the Case Manager (end user 135A) regarding the patient may transition from the Attending Provider (end user 135C) to the Vendor (end user 135C). Such mechanisms that can optimize the communication among relevant parties can significantly save time and distraction, increasing efficiency and reduce time costs for interactions among various end users 135.

It should be appreciated that conversations shifted from one end user 135 to another may also transfer a record of the past communications or messages to the new end user 135. It should also be appreciated that communication may include pre-formed or template messages. For example, “Consult requested on hospital patient,” “please contact me regarded test results for patient,” “we are releasing patient to in-home care,” and various other stored messages of clinical significance me be provided as options for communication between the clinical stakeholders.

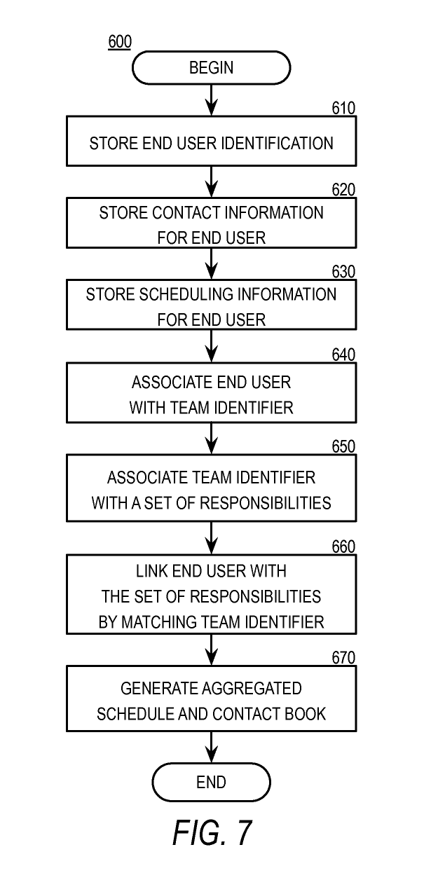

Referring now to FIG. 7, additional details will be provided regarding the embodiments presented herein for scheduling and communication coordination. In particular, FIG. 7 is a flow diagram showing a routine 600 that illustrates aspects of one process presented herein for coupling schedule and communication information.

It should be appreciated that the logical operations described herein with respect to FIG. 7 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 600 begins at operation 610, where end user identification can be stored. At operation 620, contact information for end users 135 can be stored. At operation 630, scheduling information for end users 135 can be stored. The scheduling and communication system 100 can store the identification information, contact information, and schedule information for an end user 135. The contact information may be for various communication modalities and of various scopes. The contact information may also include preferences of communication modality as a function of the type of communication, urgency level, or who is contacting the end user 135. The scheduling information can indicate the time shifts and duties associated with the end user 135. The combination of identification information, contact information, and schedule information supports identifying an end user 135, determining when and why they should be contacted according to their schedule, and determining how they should be contacted according to their contact information.

At operation 640, each end user 135 may be identified with a team identifier. In a hospital enterprise example embodiment, the end user 135 may be a clinical provider such as a hospitalist. This end user 135 may be associated with a team identifier such as Team B.

At operation 650, each team identifier may be associated with a set of responsibilities. Continuing with the hospital enterprise example embodiment, a set of responsibilities, such as a group of ten patients may be associated with a team identifier, such as Team B.

At operation 660, end users 135 may be linked with the set of responsibilities in response to having a matching team identifier. In the hospital enterprise example, the set of responsibilities (the group of ten patients) may be linked to the hospitalist according to both the patients and the hospitalist being associated with Team B.

At operation 670, an aggregated schedule and contact book may be generated according to scheduling information and team association of respective end users 135. In the hospital enterprise example, a nurse may desire to contact the clinical provider responsible for one of the patients on Team B. The nurse can obtain the team identifier for the patient as assigned in operation 650. For example, a patient may have a team identifier listed with a CIS/HIS accessible by the nurse. The nurse can now check the team identifier within the aggregated schedule and contact book using a terminal or a mobile device. From the aggregated schedule and contact book, the nurse can identify who the clinical provider is and how they should be contacted to best support accurate, timely, and appropriate communications. While this linking is a logical connection made by the nurse in this example, it should be appreciated that this logical linking is supported by the scheduling and communication system 100. Furthermore, the linking can also be made as a technological connection within the CIS/HIS, within the scheduling and communication system 100, or within both. The routine 600 can terminate after operation 670.

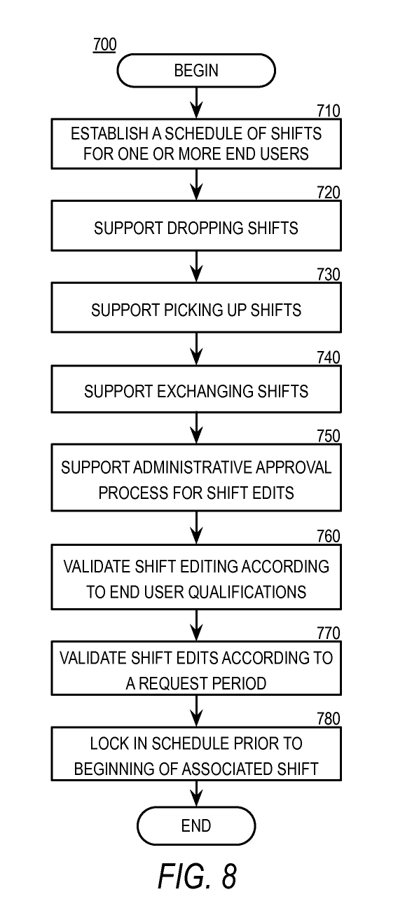

Referring now to FIG. 8, additional details will be provided regarding the embodiments presented herein for scheduling and communication coordination. In particular, FIG. 8 is a flow diagram showing a routine 700 that illustrates aspects of one process presented herein for scheduling end user shifts.

The routine 700 begins at operation 710, where a schedule of shifts for one or more end users 135 may be established. At operation 720, support may be provided for dropping shifts by an end user 135. At operation 730, support may be provided for picking up shifts by an end user 135. At operation 740, support may be provided for exchanging shifts between end users 135. At operation 750, support may be provided for administrative approval process for shift edits by an end user 135. At operation 760, support may be provided to validate shift editing according to end user qualifications. At operation 770, support may be provided to validate shift edits according to a request period. At operation 780, the updated schedule may be locked in prior to beginning of any shift associated with the schedule. The routine 700 can terminate after operation 780.

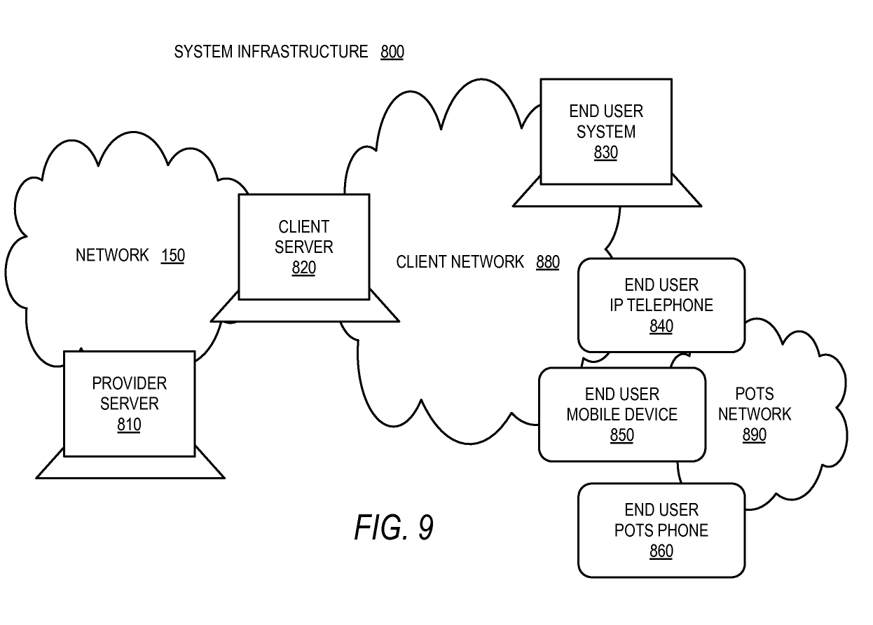

Referring now to FIG. 9, a system block diagram illustrating aspects of a system infrastructure 800 according to various embodiments presented herein will be described. A provider server 810 and a client server 820 may communicate over a network 150 as discussed above. The client server 820 may also interface to a client network 880. Devices associated with end users 135 may also communicate over the client network 880. These devices may include an end user system 830, an end user IP telephone 840, an end user mobile device 850, and various other communication systems. A plain old telephone service (POTS) network 890 may also support the end user IP telephone 840, the end user mobile device 850, an end user POTS phone 860, smart phones, office phone, home phones, pagers, alphanumeric pagers, two-way pagers, short message service (SMS) text messaging devices, and so forth. The client network 880 may be, in whole or in part, a traditional wireless network using WiFi 802.11 a/b/g/n technology or similar wireless local area network (WLAN) technology. The client network 880 may also include Bluetooth or Zigbee wireless communication technologies. The POTS network 890 may include a traditional cellular or mobile communications network just as CDMA, GSM, 3G, LTE, or wireless, mobile technologies.

It should be appreciated that the network 150 and the client network 880 may be separate networks; the same network; or may be coupled through a switch, router, firewall or other networking device. Either or both of the network 150 and the client network 880 may be the Internet, an internet, an intranet, a LAN, WAN, or any other type of communications network.

The end user IP telephone 840 may be a wireless IP telephone such as a SPECTRALINK from POLYCOM, INC. Such IP telephones are widely used in hospitals and other office and industrial settings. Their advantages include speed of user interactions, speed of call connection, audio channel fidelity, connection reliability, voice communication accuracy, end user accessibility, device durability, power management, and various other desirable characteristics.

Each of the provider server 810, client server 820, and end user system 830 may be any type of computer system, such as a traditional desktop computer, a laptop computer, a rack mounted server, a small for factor computer, or an embedded computing system. Users may access the scheduling and communication system 100 through browsers or applications connecting to other computing system or through device-specific local software applications. Modules associated with the scheduling and communication system 100 can be located locally, on a remote web server, or some combination thereof. User data, including, but not limited to, scheduling and contact information, can be stored, accessed, and manipulated remotely using a locally available network-connected device. Multiple mechanisms and technologies can be utilized to assure the scheduling and communication system 100 is highly available, highly accessible, and highly scalable such that users are well protected from loss of service, data loss, and diseconomies of scale.

In some alternative embodiments, the scheduling and communication system 100 may be supported by modules associated with a local server such as the client server 820. End users may then access the system within the client network 880 without the need for Internet connectivity. In such embodiments, the modules may include software code that can be downloaded or provided on one or more disks or other storage devices to the client 120.

The end user experience of the scheduling and communication system 100 may be available in real-time. Users may access live, or very nearly live, data thus obtaining the most current information available. End users 135 can retrieve or pull data from the scheduling and communication system 100. End users 135 may also have data pushed to them by the scheduling and communication system 100. Push notification can be utilized to send high-priority information to end users 135 or client administrative users.

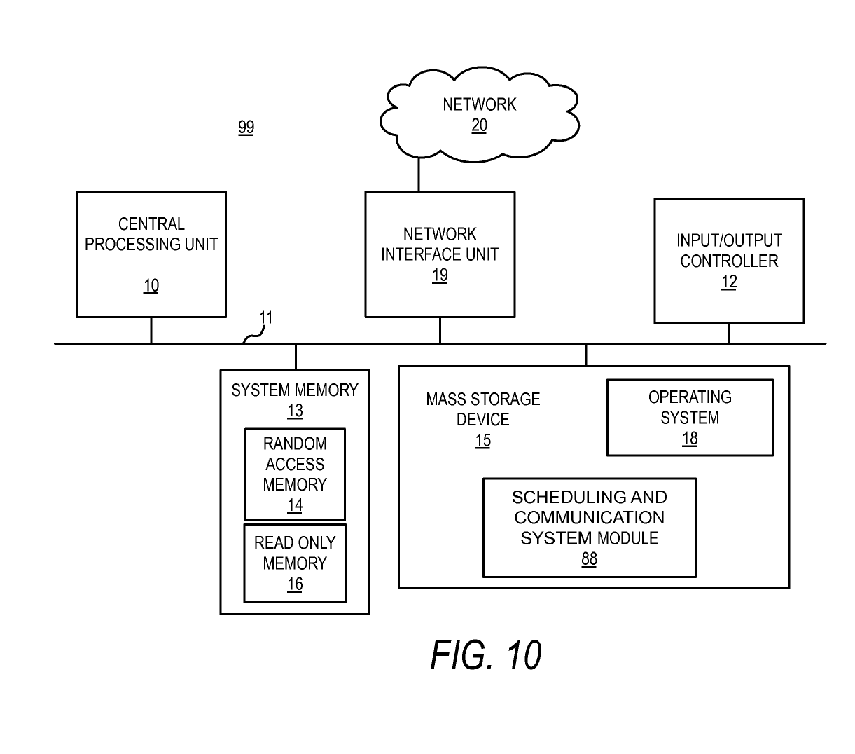

Turning now to FIG. 10, an illustrative computer architecture 99 can execute software components described herein for scheduling and communication coordination. The computer architecture shown in FIG. 10 illustrates an embedded control computer, a conventional desktop, a laptop, or a server computer and may be utilized to execute aspects of the software components presented herein. For example, the computer 99 may serve as the provider server 810, the client server 820, the end user system 830, the end user mobile device 850, or any other computational component of the scheduling and communication system 100. It should be appreciated that the described software components can also be executed on other example computing environments, such as mobile devices, television, set-top boxes, kiosks, vehicular information systems, mobile telephones, embedded systems, or otherwise.

The computer architecture illustrated in FIG. 10 can include a central processing unit 10 (CPU), a system memory 13, including a random access memory 14 (RAM) and a read-only memory 16 (ROM), and a system bus 11 that can couple the system memory 13 to the CPU 10. A basic input/output system containing the basic routines that help to transfer information between elements within the computer 99, such as during startup, can be stored in the ROM 16. The computer 99 may further include a mass storage device 15 for storing an operating system 18, software, data, and various program modules, such as a scheduling and communication system module 88.

The mass storage device 15 can be connected to the CPU 10 through a mass storage controller (not illustrated) connected to the bus 11. The mass storage device 15 and its associated computer-readable media can provide non-volatile storage for the computer 99. Although the description of computer-readable media contained herein refers to a mass storage device, such as a hard disk or CD-ROM drive, it should be appreciated by those skilled in the art that computer-readable media can be any available computer storage media that can be accessed by the computer 99.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 99.

According to various embodiments, the computer 99 may operate in a networked environment using logical connections to remote computers through a network such as the network 20. It should be appreciated that the network 20 may be the network 150, the client network 880, the POTS network 890, any combination thereof, or may be in any connection thereto.

The computer 99 may connect to the network 20 through a network interface unit 19 connected to the bus 11. It should be appreciated that the network interface unit 19 may also be utilized to connect to other types of networks and remote computer systems. The computer 99 may also include an input/output controller 12 for receiving and processing input from a number of other devices, including a keyboard, mouse, or electronic stylus (not illustrated). Similarly, an input/output controller 12 may provide output to a video display, a printer, or other type of output device (also not illustrated).

As mentioned briefly above, a number of program modules and data files may be stored in the mass storage device 15 and RAM 14 of the computer 99, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the natural language engine 130 for execution by the CPU 10. The scheduling and communication system module 88 can include software components for implementing portions of the processes discussed herein. The mass storage device 15, the ROM 16, and the RAM 14 may also store other types of program modules.

Software modules, such as the real time event driven energy management module 88 may be associated with the system memory 13, the mass storage device 15, or otherwise. The software modules may include software instructions that, when loaded into the CPU 10 and executed, transform a general-purpose computing system into a special-purpose computing system customized to facilitate all, or part of, the scheduling and communication coordination techniques disclosed herein. As detailed throughout this description, the program modules may provide various tools or techniques by which the computer 99 may participate within the overall systems or operating environments using the components, logic flows, and/or data structures discussed herein.

The CPU 10 may be constructed from any number of transistors or other circuit elements, which may individually or collectively assume any number of states. More specifically, the CPU 10 may operate as a state machine or finite-state machine. Such a machine may be transformed to a second machine, or specific machine by loading executable instructions contained within the program modules. These computer-executable instructions may transform the CPU 10 by specifying how the CPU 10 transitions between states, thereby transforming the transistors or other circuit elements constituting the CPU 10 from a first machine to a second machine, wherein the second machine may be specifically configured to support scheduling and communication coordination. The states of either machine may also be transformed by receiving input from one or more user input devices associated with the input/output controller 12, the network interface unit 19, other peripherals, other interfaces, or one or more users or other actors. Either machine may also transform states, or various physical characteristics of various output devices such as printers, speakers, video displays, or otherwise.

Encoding of the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 13 when the software is encoded therein. For example, the software may transform the state of transistors, capacitors, or other discrete circuit elements constituting the system memory 13.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

Based on the foregoing, it should be appreciated that technologies for scheduling and communication coordination are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementation.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for coordinating scheduling and communications associated with a healthcare enterprise, the method comprising computer-implemented operations for:
storing, using one or more computing devices, contact information associated with the a case manager, a clinical healthcare provider, and a vendor;
storing, using one or more computing devices, scheduling information associated with the clinical healthcare provider;
associating, using one or more computing devices, the clinical healthcare provider with a patient based upon the scheduling information;
receiving, using one or more computing devices, a request from the case manager regarding the patient;
establishing, using one or more computing devices, a relationship between the request from the case manager regarding the patient and the clinical healthcare provider based upon the scheduling information associated with the clinical healthcare provider;
establishing, using one or more computing devices, communications between the case manager and the clinical healthcare provider according to the stored contact information;
receiving, using one or more computing devices, an indication to change a status of the patient, wherein the new status involves the vendor;
establishing, using one or more computing devices, communications between the case manager and the vendor according to the stored contact information; and
terminating, using one or more computing devices, communications between the case manager and the clinical healthcare provider.

2. The computer-implemented method of claim 1, wherein the indication to change a status of the patient comprises discharging the patient from a healthcare facility.

3. The computer-implemented method of claim 1, wherein the association between the clinical healthcare provider and the patient is further based upon a team identifier associated with the clinical healthcare provider.

4. The computer-implemented method of claim 1, wherein the association between the clinical healthcare provider and the patient is further based upon a team identifier associated with the patient.

5. The computer-implemented method of claim 1, wherein the contact information comprises one of a mobile telephone number, a pager number, an email address, a text messaging number, and a voice over internet protocol number.

6. The computer-implemented method of claim 1, further comprising supporting, using one or more computing devices, editing of the scheduling information.

7. The computer-implemented method of claim 1, wherein the communications comprise selecting from a list of template messages.

8. The computer-implemented method of claim 1, wherein the scheduling information comprises shift or duty period assignments.

9. The computer-implemented method of claim 1, further comprising generating, using one or more computing devices, an aggregated common duty list in response to the scheduling information.

10. The computer-implemented method of claim 1, wherein the contact information comprises contacts for two or more communication modalities prioritized according to communication urgency.

11. A non-transitory computer-readable storage medium having computer-executable instructions stored thereon which, when executed by a computer, cause the computer to:
store identification information for one or more end users;
store contact information associated with the one or more end users;
store scheduling information associated with a first one of the one or more end users;
associate the first one of the one or more end users with a team identifier according to the scheduling information;
receive a request from a second one of the one or more end users regarding a patient;
establish communications between the first one of the one or more end users and the second one of the one or more end users according to the stored contact information and the patient being associated with the team identifier;
receive a trigger to change a status of the patient;
establish communications between the second one of the one or more end users and a third one of the one or more end users according to the stored contact information in response to receiving the trigger; and
terminate communications between the first one of the one or more end users and a second one of the one or more end users in response to receiving the trigger.

12. The non-transitory computer-readable storage medium of claim 11, wherein the trigger comprises instructions to discharge the patient from a healthcare facility.

13. The non-transitory computer-readable storage medium of claim 11, wherein the communications comprise selecting from a list of template messages.

14. The non-transitory computer-readable storage medium of claim 11, wherein the first one of the one or more end users is a clinical healthcare provider and the second one of the one or more end users is a case manager.

15. The non-transitory computer-readable storage medium of claim 11, wherein the contact information comprises one of a mobile telephone number, a pager number, an email address, a text messaging number, and a voice over internet protocol number.

16. The non-transitory computer-readable storage medium of claim 11, wherein the scheduling information comprises one of shift assignments and duty period assignments.

17. The non-transitory computer-readable storage medium of claim 11, wherein the computer is further caused to generate an aggregated common duty list in response to the scheduling information.

18. The non-transitory computer-readable storage medium of claim 11, wherein the contact information comprises contacts for two or more communication modalities.

19. The non-transitory computer-readable storage medium of claim 18, wherein the two or more communication modalities are prioritized according to communication urgency.

20. A computer system comprising:
a processing unit;
a memory operatively coupled to the processing unit; and
a program module which executes in the processing unit from the memory and which, when executed by the processing unit, causes the computer system to
store contact information associated with a case manager, an attending provider, and a vendor;
store scheduling information associated with the attending provider;
associate the attending provider with a team identifier according to the scheduling information;
receive a request from the case manager regarding a patient;
establish communications between the attending provider and the case manager according to the stored contact information and the patient being associated with the team identifier;
receive a trigger to change a status of the patient from the attending provider;
establish communications between the case manager and the vendor according to the stored contact information in response to receiving the trigger; and
terminate communications between the attending provider and the case manager in response to receiving the trigger.
